(19) United States
(12) Patent Application Publication
(10) Pub. No.: US 2025/0117902 A1
(43) Pub. Date: Apr. 10, 2025

(54) ARTIFACT REDUCTION FOR REMASTERING DYNAMIC RANGE CONTENT USING NEURAL NETWORKS

(71) Applicant: NVIDIA CORPORATION, Santa Clara, CA (US)

(72) Inventors: Donald Lee BRITTAIN, Pasadena, CA (US); Andrew Ian RUSSELL, Weston, FL (US); Anjul PATNEY, Kirkland, WA (US); Yinghao XU, San Jose, CA (US); Shaveen KUMAR, Vancouver (CA)

(21) Appl. No.: 18/482,753

(22) Filed: Oct. 6, 2023

(51) Int. Cl. G06T 5/00; G06T 3/40; G06T 5/20; G06T 7/00; G06T 7/60; G06T 7/70

(52) U.S. Cl. CPC G06T 5/90; G06T 3/4046; G06T 5/20; G06T 5/73; G06T 7/0002; G06T 7/60; G06T 7/70; G06T 2207/10016; G06T 2207/10024; G06T 2207/20028; G06T 2207/20081; G06T 2207/20084; G06T 2207/20208; G06T 2207/30168

(57) ABSTRACT

In various examples, disclosed techniques use a banding detector neural network to identify the locations and sizes of banding artifacts in pixel regions of an input image. The neural network generates a band size map that identifies at least one banding artifact in the input image. The band size map can include a set of predicted band size values, each of which corresponds to a respective pixel of the input image and represents a distance between edges of a banding artifact. The band size map and the input image are provided as input to a stochastic bilateral blur filter, which generates a de-banded image by applying blurring effects to the input image at the band locations indicated by the band size map. An inverse tone mapping operation is then performed to convert the de-banded image to an image that does not have banding artifacts.

### BACKGROUND

High Dynamic Range (“HDR”) content includes image data or video data that has a wide range of brightness levels. Dynamic range of content is a measure of the ratio between a minimum light intensity in an image and a maximum light intensity in the image. In particular, HDR content has a wider range of brightness levels than Standard Dynamic Range (“SDR”) content. A large amount of media content uses SDR format, such as movies, digital images, and video game graphics. When such SDR content is displayed on an HDR-capable screen, the displayed images that are produced have brightness values within the SDR dynamic range, which is substantially lower than the HDR dynamic range. Accordingly, it is desirable to be able to convert SDR content to HDR content. Various approaches have been implemented to convert SDR content to HDR content. Such conversion approaches can involve mapping the brightness levels of the SDR content to a wider range of brightness levels, for example.

One drawback of prior techniques that convert SDR to HDR images is that the resulting HDR images frequently contain banding artifacts that appear as bands of different brightness. These bands are produced as a result of expanding the brightness range of the quantized SDR image, and are especially prominent in brighter parts of the image. The number of brightness levels represented in the input image is significantly smaller than the number of brightness levels displayed in an HDR image at 400-1000 candela per square meter, so a stair-stepping between noticeably different brightness levels can occur in the conversion. This stepping between brightness levels appears as the bands in the HDR image. Further, banding artifacts can also appear in other operations involving HDR images. For example, when HDR images are transmitted over a computer network to a display device. The HDR images are compressed prior to being transmitted, and the compressed HDR images are de-compressed at the display device. The compression and de-compression process can produce banding artifacts because of the limited number of brightness levels represented in the compressed HDR images. The bands are often clearly visible in displayed HDR images and detract from the realism of the images. To address this banding problem, various approaches have been implemented to remove banding artifacts during the SDR to HDR conversion process or from existing HDR images.

One drawback of prior techniques that remove HDR banding artifacts is that they are time-consuming and unsuitable for use in real-time or near-real time applications. For example, prior techniques are not suitable for converting streaming video while the video is being streamed from a server to a client device on which the video is displayed or in a video game being played on a computer, phone, or console. Prior conversion techniques generate HDR images at rates lower than video frame rates, so those techniques convert SDR content to a resulting HDR file, which is stored in persistent storage such as a disk or database.

Accordingly, there is a need for improved techniques for efficiently removing banding artifacts from SDR image or video content and/or converting image or video content to higher dynamic range content while reducing banding artifacts.

### SUMMARY

Embodiments of the present disclosure relate to artifact reduction for image content. The techniques described herein include receiving an input image having a first dynamic range. The techniques also include processing, using a banding detector neural network, the input image to generate a band size map that identifies at least one banding artifact in the input image. The techniques further include generating, using a blur filter, a de-banded image based on the band size map and the input image, where the blur filter removes at least a portion of a banding artifact from the input image. The techniques further include generating, based on the de-banded image, an output image having a second dynamic range greater than the first dynamic range.

One technical advantage of the disclosed techniques relative to prior approaches is the ability to remove banding artifacts from an image in a short amount of time. Prior approaches generate SDR images at rates lower than video frame rates, so those techniques convert SDR content to a resulting HDR file, which is stored in persistent storage—such as a disk or database. The disclosed techniques remove banding artifacts in real-time (or near real-time), so that SDR content can be converted to HDR content while the content is being transmitted over a network. Prior approaches are substantially slower and are unable to process images at a rate sufficient to remove bands from video frames while a video is being streamed from a server to a client device via a computer network. Instead, prior approaches perform de-banding on video data prior to streaming—e.g., by converting a video file to a de-banded video file prior to streaming. The de-banded video file consumes additional storage space. Another technical advantage of the disclosed techniques is better preservation of texture details from the SDR input image in the HDR output image and elimination of more and/or wider banding artifacts than are eliminated in prior approaches.

### BRIEF DESCRIPTION OF THE DRAWINGS

The present systems and methods for determining an ordering of inputs received from multiple sensors in autonomous and semi-autonomous systems and applications are described in detail below with reference to the attached drawing figures, wherein:

FIG. 1 illustrates a computing device configured to implement one or more aspects of various embodiments;

FIG. 2A is a more detailed illustration of the training engine of FIG. 1, according to various embodiments;

FIG. 2B illustrates an example banding detector network, according to various embodiments;

FIG. 2C illustrates an example multi-channel band size map and an example scalar band size map, according to various embodiments;

FIG. 3 is a more detailed illustration of the execution engine of FIG. 1, according to various embodiments;

FIG. 4 illustrates an example stochastic bilateral blur filter, according to various embodiments;

FIG. 5 illustrates a flow diagram of a method for training a banding detector network, according to various embodiments;

FIG. 6 illustrates a flow diagram of a method for reducing banding artifacts in an image, according to various embodiments; and

FIG. 7 is a block diagram of an example computing device suitable for use in implementing some embodiments of the present disclosure.

### DETAILED DESCRIPTION

Systems and methods are disclosed for artifact reduction for image and/or video content. The disclosed techniques use a neural network (a banding detector) to identify parts of an input image that contain banding, or will likely contain banding after conversion to HDR, and then use a bilateral blur filter to remove or reduce the banding by dynamically blurring the input image near the edges of the bands. The input image can be an SDR image, for example. The resulting de-banded image produced by the bilateral blur filter can be converted to a higher dynamic range image, such as an HDR image, in which banding is not present or is reduced. More specifically, the banding detector predicts the sizes of bands in pixel regions of the input image. The size of a band is referred to herein as a “band size.” The band size can be, for example, a width of the band in pixels or other units of measurement. The output of the banding detector is a band size map that includes a set of band size values, each of which corresponds to a respective pixel of the input image. Each band size value in the output map represents a size of a band that contains the corresponding pixel location in the input image. This size of the band at a particular pixel location can be, for example, a width of the band at the pixel location. The width of the band can be a distance between opposite edges of the band. The opposite edges can be parallel edges, and can be the top and bottom edges of the band, for example. A particular band size map can specify a particular band size. The banding detector network can be a nested binary classifier that has a wide receptive field capable of detecting wide bands, and that outputs the band size map in the form of binary classifications associated with pixels of the input image. The band size map and the input image are provided as input to a bilateral blur filter, which generates a de-banded image by removing the bands indicated by the band size map from the input image. Since the band size map associates band sizes with pixels, the band sizes can vary as appropriate for different pixel locations. The bilateral blur filter can be a stochastic bilateral blur filter that accesses a randomized subset of the neighborhood pixels in the input image when calculating each output pixel. The stochastic bilateral blur filter determines a probability of using each neighborhood pixel in the input image according to a random distribution, applies the filter to pixels of the input image, and accesses pixels according to the probability. An inverse tone mapping operation is then performed to increase the dynamic range of the de-banded image.

One technical advantage of the disclosed techniques relative to prior approaches is the ability to remove banding artifacts from an image in a short amount of time. Prior approaches generate SDR images at rates lower than video and gaming frame rates, so those techniques convert SDR content to a resulting HDR file, which is stored in persistent storage such as a disk or database. In contrast, techniques according to one or more embodiments remove banding artifacts in real time, so that SDR content can be converted to HDR content within a short amount of time after the content is generated, such as when the content is rendered in a computer game or while the content is being transmitted over a network. Prior approaches are substantially slower and are unable to process images at a rate sufficient to remove bands from video frames while a video is being streamed from a server to a client device via a computer network. Instead, prior approaches perform de-banding on video data prior to streaming—e.g., by converting a video file to a de-banded video file prior to streaming. Another technical advantage of the disclosed techniques is better preservation of texture details from the SDR input image in the HDR output image and elimination of more of the banding artifacts than are eliminated in prior approaches.

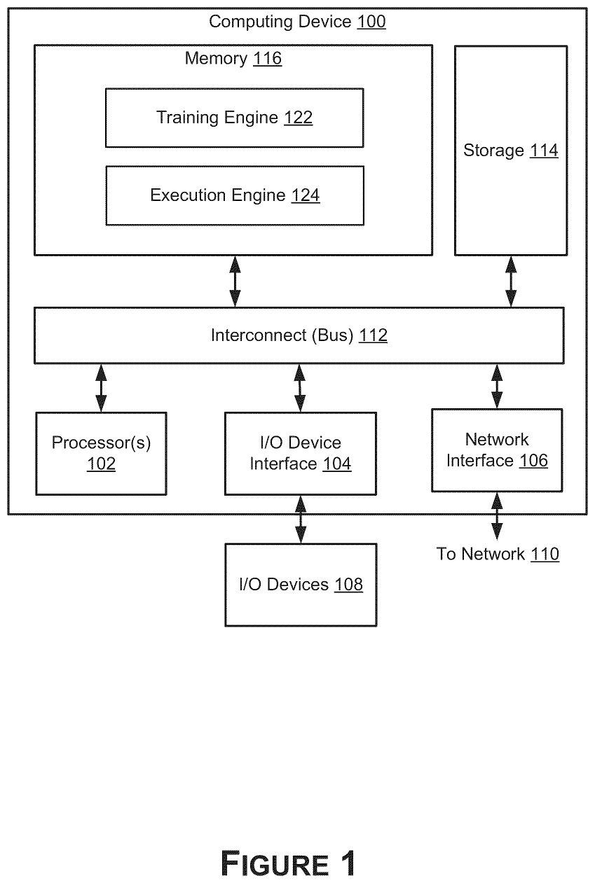

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, a system on a chip, a computing system of an autonomous, semi-autonomous, or a non-autonomous machine, and/or any other type of computing device configured to receive input, process data, and optionally display information, and is suitable for practicing one or more embodiments. Computing device 100 is configured to run a training engine 122 and an execution engine 124 that may reside in a memory 116. It is noted that the computing device described herein is illustrative, and that any other technically feasible configurations fall within the scope of the present disclosure. For example, multiple instances of training engine 122 and/or execution engine 124 may execute on a set of nodes in a distributed and/or cloud computing system to implement the functionality of computing device 100.

In at least one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center or a machine) and/or may correspond to a virtual computing instance executing within a computing cloud.

In at least one embodiment, I/O devices 108 include devices capable of receiving input, such as a keyboard, a mouse, a touchpad, a VR/MR/AR headset, a gesture recognition system, a steering wheel, mechanical, digital, or touch sensitive buttons or input components, and/or a microphone, as well as devices capable of providing output, such as a display device, haptic device, and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In at least one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, a cellular network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and/or execution engine 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs or more generally software code that can be executed by processor(s) 102 and application data associated with said software programs, including training engine 122 and/or execution engine 124.

Training engine 122 includes functionality to train a banding detector network to generate a predicted band size map 206 based on an input image. More specifically, training engine 122 is configured to perform a sequence of training iterations, each of which uses the banding detector network to convert an input image to a predicted band size map and updates the banding detector network based on an amount of loss 210 between the predicted band size map and a target band size map. The input image is one of a set of training input images in a set of training data pairs. The target band size map is from the same training data pair as the training input image. Training engine 122 uses banding detector network to convert each training input image to a respective predicted band size map. For each predicted band size map, training engine 122 determines a band size map loss using a suitable loss function based on the predicted band size map and a target band size map. The target band size map is one of the training band size maps, and corresponds to the training input image provided as input to the banding detector network. The loss function can calculate the loss based on a difference between the predicted band size map and the target band size map. The training engine 122 can update the banding detector network based on the band size map loss, e.g., by updating weights or other parameters of the banding detector network using backpropagation or other suitable training technique. Some embodiments may exclude the training engine 122, and execution engine 124 may instead use a banding detector network (e.g., a neural network) that was produced by a previous run of the training engine 122.

Execution engine 124 includes functionality to use a trained banding detector network to identify parts of an input image that contain banding, or will likely contain banding after conversion to HDR, and then use a blur filter to remove or reduce the banding by blurring the input image at the edges of the bands. More specifically, execution engine 124 converts an input image into a predicted band size map using a banding detector network, convert the predicted band size map to a de-banded image using a bilateral blur filter, and convert the de-banded image to an output image using an inverse tone mapper. The output image is based on the input image, but banding artifacts depicted in the input image are reduced or removed in the output image.

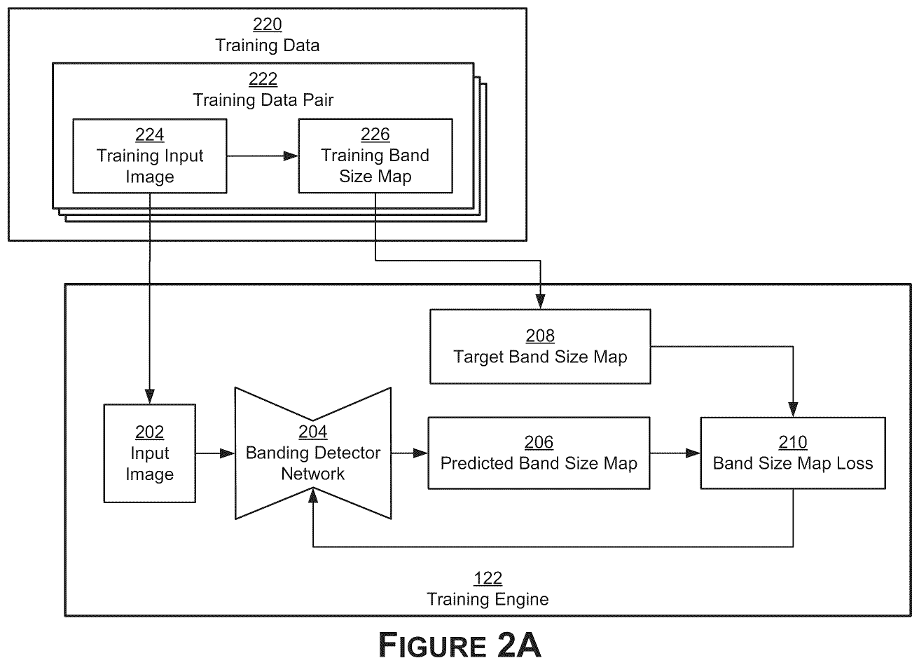

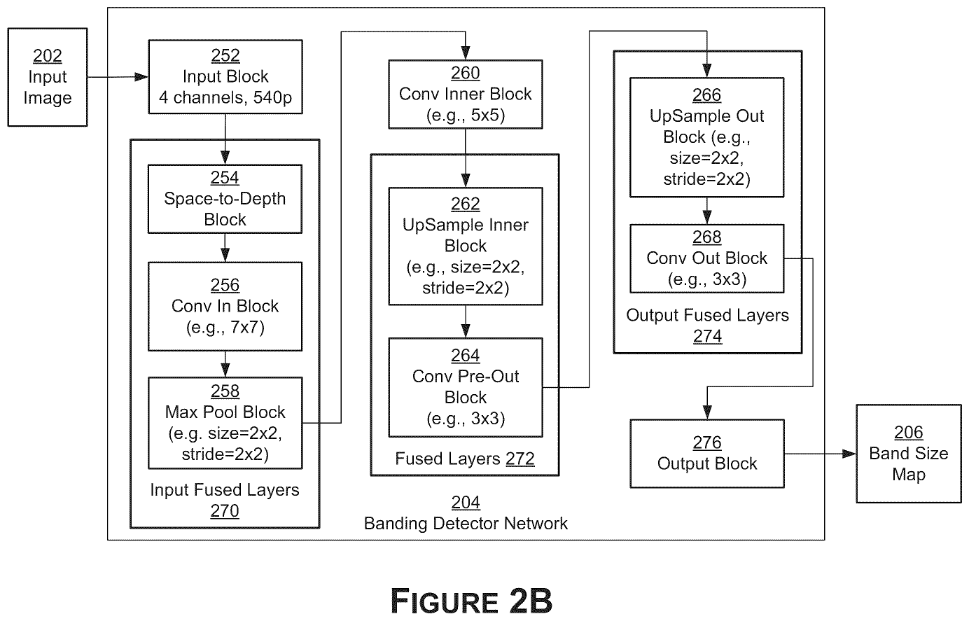

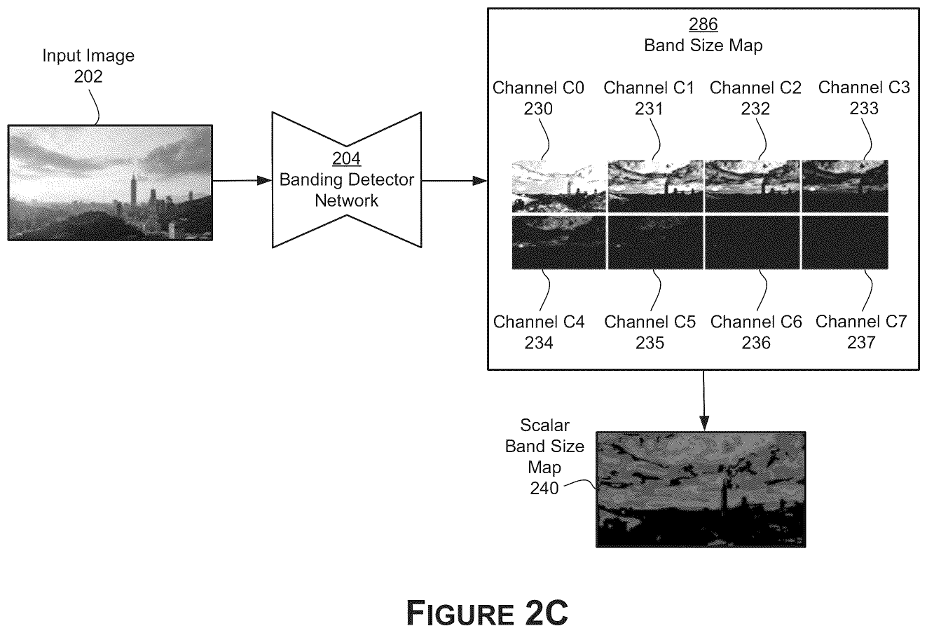

FIG. 2A is a more detailed illustration of the training engine 122 of FIG. 1, according to various embodiments. Training engine 122 includes functionality to train a banding detector network 204 to convert an input image 202 that has banding artifacts to a predicted band size map 206 that identifies locations and sizes of banding artifacts in the input image 202. The banding detector network 204 predicts the sizes of banding artifacts, referred to herein as band size values, in different pixel regions of the input image 202. The banding detector network 204 can be, for example, a Convolutional Neural Network (CNN) having multiple layers that process different levels of the receptive field of the input image. Other types of neural networks can be used, such as a transformer or a variational autoencoder.

The output of the banding detector network 204 is a predicted band size map 206 that includes a set of band size values, each of which corresponds to a respective pixel of the input image 202. For example, the predicted band size map 206 can be represented as a set of one or more images, referred to herein as “channels”, and each band size value can correspond to a pixel location (e.g., x, y coordinates) in each of the images. Each band size value in the predicted band size map 206 can represent a predicted size of a band that contains the corresponding pixel location in the input image 202. In some embodiments, each band size value is a scalar value referred to herein as a “scalar band size value” A scalar band size value can be selected from a set of possible scalar band size values or can be within a range of values, for example. A scalar band size value specifies a predicted size of a band that includes a corresponding pixel location in the input image 202. The corresponding pixel location is the location (e.g., x and y coordinates) of the pixel to which the scalar band size value corresponds in the band size map 206. In such embodiments, each scalar band size value is sufficient to specify a band size, so a single channel having scalar band size values can represent the band sizes. Further, banding detector network 204 generates a scalar band size map 240, which can be used as the band size map 206 (without generating a multi-channel band size map 286). However, to detect wide bands, the banding detector network 204 should have a large receptive field. In some implementations, neural network models having large receptive fields and the operations involved in generating scalar band size values tend to execute slowly because of the amount of data processing involved in processing larger portions of the input image.

In some embodiments, to increase the size of the receptive field that can be processed by the banding detector network 204 while maintaining desired processing speed (e.g., at a rate suitable for detecting bands in streaming video frames), the banding detector network 204 is a nested binary classifier, and the predicted band size map 206 is represented in a nested binary classification format. The nested binary classification format is based on the “nesting” property of band artifacts. According to the nesting property, an input pixel that is not within a given band is also not within a larger band that includes the given band. Because of the nesting property, the banding detector network 204 can be a nested binary classifier, which reduces the amount of computation performed by the banding detector network 204 so that a large receptive field can be processed in a relatively short amount of time. In one or more embodiments, the banding detector network 204 can use a ReLu activation function in tensor cores of a processor (such as, for example and without limitation, a CPU, GPU, DPU, or a hardware accelerator) to efficiently process the thresholds.

In the nested binary classification format, the predicted band size map 206 includes a set of N channels. Each channel is associated with an upper band size threshold, and higher-numbered channels are associated with higher upper band size thresholds. The channels 230-237 in the band size map 286 correspond to progressively greater respective band sizes. For example, each channel number i can correspond to a threshold band size that is based on the quantity 2ⁱ. Channel 0 can correspond to a threshold band size of 1 pixel, channel 1 to a threshold band size of 2 pixels, and so on, up to channel 7, which can correspond to a threshold band size of 128 pixels (or other units). Each channel is associated with a set of binary band size values that correspond to pixels of an image that can contain banding. Thus, in the nested binary classifier, each band size value is a binary value that is either 0 or nonzero (or other suitable values, e.g., either 0 or 1, or other values that correspond to true or false). Each binary value indicates whether the corresponding pixel of the image is in a band having a size greater than the threshold band size of the channel. Each binary value can be either zero or non-zero. A binary value of 0 indicates that the corresponding pixel of the image is not in a band having a size greater than the threshold band size of the channel. A non-zero binary value indicates that the corresponding pixel of the image is in a band having a size greater than the threshold band size of the channel. The threshold band size of each channel does not necessarily specify the size of a band directly. For example, the threshold band size can be proportional to the size of a band, e.g., proportional to the distance between the two edges of the band.

The predicted band size map 206 can be used to remove the banding artifacts from the input image 202 and generate an output image in which the banding has been reduced or removed, as described herein. As described above, the band size map 206 can specify the band sizes as a set of channels, where each channel specifies binary values predicted by the banding detector network 204. Each binary value in a channel indicates whether the band at a pixel of the input image that corresponds to the position of the binary value in the band size map 206 has a size that is greater than a threshold value associated with the channel. Although the “greater than” relation is used in examples described herein, any suitable relation can alternatively be used to compare the band size to the threshold value, e.g., greater than, less than, less than or equal to, or greater than or equal to. As described above, the band size map 206 can specify the band sizes as scalar band size values, e.g., a value of “4” can represent a band having a width of 4 pixels at a pixel of the input image that corresponds to the position of the scalar band size value in the band size map 206. Alternatively, as described above, the band size map 206 can specify the band sizes as scalar values that are predicted by the banding detector network 204. For example, a scalar band size value of “4” can represent a band having a width of 4 pixels at a pixel of the input image that corresponds to the position of the scalar band size value in the band size map 206. If the band size map 208 specifies scalar band size values, then the band size map is referred to herein as having one channel in which the values are scalar band size values instead of the binary values specified in band size maps having multiple channels. Portions of the input image 202 that do not include banding artifacts are reproduced in the output image with no changes. The term “de-banding” is used herein to refer to removal or reduction of banding artifacts from an image. The input images 202 can be 8-bit SDR images, for example.

An example 8-channel band size map 286 generated by banding detector network 204 is shown in FIG. 2C. The 8-channel predicted band size map 286 has 8 nested levels of pixels and is represented by 8 monochrome images, each of which represents a respective channel in a set of 8 channels C0 230 through C7 237. As can be seen in FIG. 2C, an image representation of a channel C0 230 having an associated band size threshold of 1 pixel has most or all pixels activated (on) and thus illustrates that most or all of the pixels of an input image 202 are in bands having sizes greater than 1 pixel. Each active (on) pixel in each channel indicates that a corresponding pixel of input image 202 is in a band having a size greater than 1 pixel.

As shown in FIG. 2C, an image representation of a channel C1 231 having an associated band size threshold of 2 pixels has many pixels activated (on) and thus illustrates that many of the pixels of input image 202 are in bands having sizes greater than 2 pixels. Channel C1 231 has fewer active (on) pixels than channel C0 230, which indicates that fewer pixels of the input image 202 are in bands sizes greater than 2 pixels than are in bands of size greater than 1 pixel. The number of activated (on) pixels in each of the successive input images 232-237 for respective channels C2-C7 is progressively smaller, indicating that fewer pixels of the input image 202 are in bands of the greater sizes corresponding to channels C2-C7. Channel C7 237, for example, corresponds to bands of size 128 pixels. There are no active (on) pixels in the image representation of the channel C7 237, illustrating that no pixels of the input image 202 are in bands of sizes greater than 128 pixels. The monochrome images 230-237 of channels C0-C7 of the band size map 286 are combined into a scalar band size map 240 in which each pixel at a location (x, y) is based on a combination of the pixel values at location (x, y) in each of the monochrome images 230-237. Since each pixel in the scalar band size map 240 is a scalar having a value that can be one of a range of color values, the scalar band size map 240 is shown as a color image.

Training engine 122 performs a sequence of training iterations, each of which uses the banding detector network 204 to convert an input image 202 to a predicted band size map 206 and updates the banding detector network 204 based on an amount of loss 210 determined between the predicted band size map 206 and a target band size map 208. Training engine 122 trains the banding detector network 204 using training data 220. The training data 220 includes a set of training data pairs 222, each of which includes a respective training input image 224 and a respective training band size map 226, which is an expected (e.g., “ground truth”) output of the banding detector network 204 for the respective training input image 224. The number of training data pairs 222 can be, for example, 1000, 1500, 2000, or other suitable number of pairs. Each training input image 224 can be an 8-bit RGB (Red Green Blue) image, and each training band size map 226 can be an N-channel binary image that represents N possible band size values. Each channel represents a band size level, which represents a range of band size values. The number of channels N can be, for example, 8, 16, 32, or other suitable number of channels. A particular training band size map 226 specifies a band size level for each pixel in the respective training input image 224.

The training input image 224 can be generated from HDR images that were captured from HDR content such as HDR video game screens, HDR videos, or other suitable HDR content. Each HDR image is tone-mapped to the range 0.0 to 1.0 using the mapping v/(1+v) where v is the value of an HDR pixel. A band size-finding algorithm is used to determine a band size for each pixel in the tone-mapped image. The band size-finding algorithm determines the distance from each image pixel to the nearest pixel in the image that differs from the image pixel by more than a threshold amount in any color channel. The threshold can be, e.g., 1/255 or other suitable value. The tone-mapped image is quantized to produce an 8-bit training input image 224. The respective training band size map 226 for the training input image 224 is generated by, for each pixel of the training input image 224, setting the channel associated with the pixel in the respective training band size map 226 to a value that represents the band size value of the pixel.

In each training iteration, training engine 122 uses banding detector network 204 to convert a training input image 224 to a respective predicted band size map 206. For each predicted band size map 206, training engine 122 determines a band size map loss 210 using a suitable loss function based on the predicted band size map 206 and a target band size map 208. The target band size map 208 is one of the training band size maps 226, and corresponds to the training input image 224 that is provided as input to the banding detector network 204. The loss function can calculate the loss based on a difference between the predicted band size map 206 and the target band size map 208 from the same training data pair 222 as the training input image 224 that is provided as an input image 202 to banding detector network 204. The training engine 122 can update the banding detector network 204 based on the band size map loss 210, e.g., by updating weights or other parameters of the banding detector network 204 using backpropagation or other suitable training technique. The predicted band size map 206 and target band size map 208 can be images or sets of images, and the loss can be computed based on an image difference. The loss function can be a quadradic mean squared error function, cross-entropy function, weighted cross-entropy function, or other suitable loss function.

In some embodiments, the training engine 122 can be trained to generate predicted band size maps 206 for use in de-banding SDR images that are subsequently converted to higher dynamic range (e.g., HDR) images. If the training engine 122 is to be used for de-banding SDR images that are subsequently converted to HDR images, then the training input images 224 can be generated from HDR images that were captured from HDR content, as described above. In other embodiments, the disclosed techniques can be used to remove bands from SDR (e.g., 8 bits per pixel) images or other images that are not subsequently converted to higher dynamic range images, in which case the input images used to train the banding detector network can be generated from SDR images or other non-HDR images. The resulting de-banded SDR images can be stored using 16 or more bits per pixel, or processed using dithering, to avoid re-introducing banding.

FIG. 2B illustrates an example banding detector network 204, according to various embodiments. Banding detector network 204 converts an input image 202 to a predicted band size map 206. Banding detector network 204 is a convolutional neural network. Banding detector network 204 includes an input block 252, three sets of fused layers 270, 272, 274, and an output block 276. Each fused layer includes two or more blocks that are executed by program code that executes efficiently within a tensor core processor or other computation accelerator. The input block 252 down-samples the input image 202 from a higher resolution, such as 4K, to a lower resolution, such as 540p. The input image 202 can have red, green, and blue color channels. Note that the image channels are different from the channels of the band size map 206 described herein. The input block 252 provides the image channels of the down-sampled image to a space-to-depth block 254, which restructures the input image channels by reducing the width and height of each channel (e.g., each feature map) and increasing the number of channels (e.g., feature maps). For example, the space-to-depth block 254 can convert a 4×4 input feature map to 4 2×2 feature maps by selecting 4 sets of 4 pixels from the initial 4×4 feature map and creating 4 feature maps, each containing one of the sets of 4 pixels. Thus, the resolution of each channel is reduced, and the number of channels is increased. If the GPU tensor cores operate on multiples of 8 channels, for example, the space-to-depth block 254 can convert the 4-channel input into 16 channels, in which case the width and height pixel dimensions of each channel are divided by two. Stacking the input image into multiple channels in this way increases the size of the receptive field. For example, stacking the input image into 16 channels doubles the receptive field.

In one or more embodiments, conv-in block 256 includes a CNN that performs a convolution operation on the result of the space-to-depth block 254. A CNN provides a convolution operator that performs convolution operations. The CNN may be trained by the training engine 122 using training input images 224 that depict training patterns. The convolution operator receives input, identifies patterns, which are learned during training, in the input, and produces output based on the combination of learned patterns that are present in the input. This identification is performed using cross-correlations of input tensor values, where the neighborhood of input values considered during the computation of each output value is based on parameters of the convolution operator (such as filter size, e.g., 3×3 or 7×7, input feature/channel counts, etc.).

The output of a convolution operator is a tensor that represents a map of the patterns that are present in the input. The more output features (e.g., channels) there are in the input, the richer the pattern map becomes. However, if the number of output features is too high, then the map stores extra pattern information. The extra pattern information can be unnecessary or detrimental. The feature counts of a CNN are chosen to optimize the accuracy of the CNN so that it stores the useful patterns, but not the unnecessary or detrimental patterns. The conv-in block 256 processes 32 features and uses a leaky ReLU activation function. Each feature corresponds to a channel in the image output by a convolution. The example conv-in block 256 takes a 16-channel input 254 and outputs a 32-channel image. For example, the conv-in block 256 can perform a 7×7 convolution, in which the kernel size is 7×7 pixels. A max pool block 258 having pooling size of 2×2 identifies the maximum values produced by the conv-in block 256 and reduces the dimensions of the image by dividing the width and height by 2. The max pool block 258 thus doubles the size of the receptive field again. The space-to-depth block 254, conv-in block 256, and max pool block 258 are fused together as input fused layers 270 that are efficiently executed by tensor cores of the GPU. The banding detector network 204 then performs a 5×5 convolution shown as a conv-inner block 260 on the output of the max pool block 258. The conv-inner block 260 processes 64 features and uses a leaky ReLU activation function. The result of the conv-inner block 260 is provided to an upsample-inner block 262 as input. The upsample-inner block 262 increases the size of the input by a factor of 2×2 (e.g., 2 in height and 2 in width) using filtered upsampling of the band size prediction. The result of the upsample-inner block 262 is provided to a conv-pre-out block 264 block as input. The conv-pre-out block 264 performs a 3×3 convolution on the input. The upsample-inner block 262 and the conv-pre-out block 264 are executed as inner fused layers 272. The output of the conv-pre-out block 264 is provided to an upsample-out block 266, which increases the size of its input by a factor of 2×2. The upsampled output of the upsample-out block 266 is provided as input to a conv-out block 268, which performs a 3×3 convolution. The upsample-out block 266 and conv-out block 268 are executed as output fused layers 274. An output block 276 converts the result of the conv-out block 268 to the predicted band size map 206. Although examples are described herein with reference to particular image resolutions, the techniques discussed herein can also be used with any suitable image resolutions. Further, although examples are described herein with reference to particular neural networks and neural network parameters, such as convolution kernel size and stride, space to depth sizes, max pool size, and up-sampling factors, the techniques discussed herein can also be used with any suitable neural networks and neural network parameters.

FIG. 2C illustrates an example multi-channel band size map 286 and an example scalar band size map 240, according to various embodiments. A banding detector network 204 converts an input image 202 to the band size map 286, which can also be converted to a scalar band size map 240 (e.g., by a training engine 122 or execution engine 124). The band size map 286 includes 8 channels referred to as C0-C7. An image representation of a channel C0 230 of the having an associated band size threshold of 1 pixel has most or all pixels are white (e.g., values=0) and thus illustrates that most or all of the pixels of an input image 202 are in bands having sizes greater than 1 pixel. Each white pixel in each channel indicates that a corresponding pixel of input image 202 is in a band having a size greater than 1 pixel. An image representation of a channel C1 231 having an associated band size threshold of 2 pixels has many white pixels and thus illustrates that many of the pixels of input image 202 are in bands having sizes greater than 2 pixels. Channel C1 231 has fewer white pixels than channel C0 230, indicating that fewer pixels of the input image 202 are in bands having size greater than 2 pixels than are in bands having size greater than 1 pixel. The number of white pixels in each of the successive input images 232-237 for respective channels C2-C7 is progressively smaller, indicating that progressively fewer pixels of the input image 202 are in bands of greater sizes as the channel number increases. Channel C7 237, for example, corresponds to bands having size 128 pixels. There are no white pixels in the image representation of the channel C7 237, illustrating that no pixels of the input image 202 are in bands of size greater than 128 pixels. The monochrome images 230-237 of channels C0-C7 of the band size map 286 are combined into a scalar band size map 240 in which the value of each pixel at a location (x, y) is based on a combination of the pixel values at location (x, y) in each of the monochrome images 230-237. Each pixel in the scalar band size map 240 is a scalar having a value that is one of a range of color values, so the scalar band size map 240 is shown as a color image. Although examples are described herein with reference to 8 channels, the techniques discussed herein can also be used with any suitable number of channels, and/or with scalar band size map(s) directly output by the banding detector network.

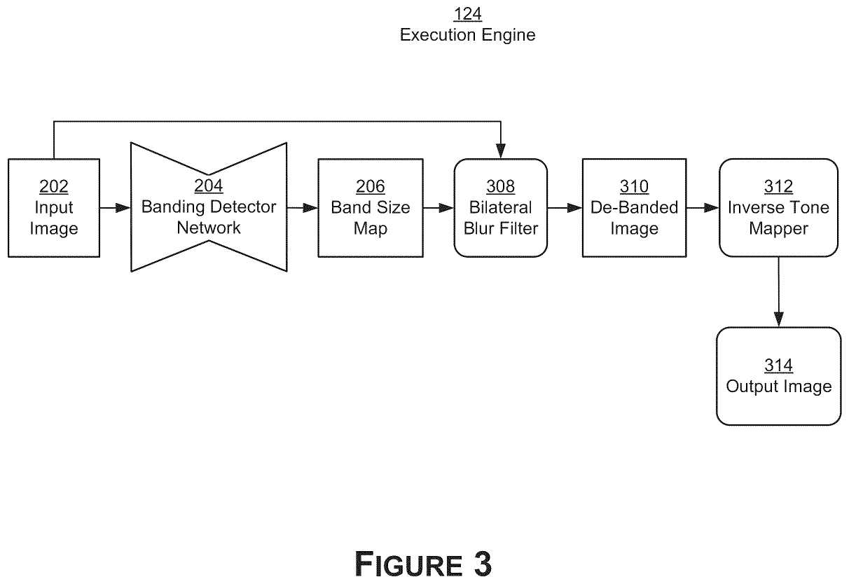

FIG. 3 is a more detailed illustration of the execution engine 124 of FIG. 1, according to various embodiments. Execution engine 124 converts an input image 202 that includes one or more banding artifacts to an output image 314 in which the banding artifacts have been reduced or removed. The input image can be included in a frame of content being streamed or displayed, for example. The content can include one or more digital photographs, video, video game screens, or other image content, for example. Execution engine 124 generates the output image 314 by copying or otherwise incorporating portions of the input image 202 that do not depict edges of banding artifacts, and blurring portions of the input image 202 that do depict edges of banding artifacts. Execution engine 124 provides the input image 202 to a banding detector network 204, which identifies identify portions of the input image 202 that contain banding artifacts, or will likely contain banding artifacts after conversion to HDR, and generates a predicted band size map 206 that specifies the locations of the identified banding artifacts. The input image 202 can be an 8-bit image in SDR format, for example. Execution engine 124 can resize the input image 202 to 540p or other suitable resolution for input to the banding detector network 204.

Execution engine 124 provides the predicted band size map 206 and the 540p input image 202 to a bilateral blur filter 308, which blurs the portions of the input image 202 specified in the predicted band size map 206, thereby reducing or removing the banding artifacts. The bilateral blur filter 308 applies a different band size bilateral filter at in different areas of the input image 202 in accordance with the band sizes specified in the predicted band size map 206. A bilateral filter blurs the by blurring the edges of each detected band in the input image 202 so that the band edges are no longer depicted in the input image 202.

In some embodiments, to improve the vibrance of colors shown on HDR displays, the saturation of output RGB values in an output image is increased by a specified amount, e.g., by 25% or 30%. For example, if HDR format is being used for the output image, the RGB values in the de-banded image can be increased prior to generating an output image based on the de-banded image, or the RGB values in the output image can be increased. In some cases, this increase can cause the individual R, G, and B values to become negative or greater than 1.0, which can introduce artifacts such as shifts in image color. To avoid these artifacts, the output HDR image can be converted from RGB color space to a target color space in which artifacts are reduced, such as a CIE-LAB or OkLab, or other (different) LAB color space, or an LCH (Luminance Chroma Hue) color space associated with CIE-LAB or OkLab, or a different LAB color space. Colors in an LCH color space are specified as a combination of luminance, chroma, and hue values. Examples of LCH color spaces include the CIE-LCH (International Commission on Illumination-LCH) and OkLab-LCH color spaces. For example, in an LCH color space, or in conversion of the output HDR image to an LCH color space, a binary search can be used to reduce chromaticity (C) of each pixel without modifying lightness (L) or hue (H). The chromaticity (C) of each pixel is reduced to a reduced value for which each of the R, G, and B values is in a predetermined range, e.g., between 0 and 1. For example, in the binary search, the chromaticity (C) of each pixel can be reduced until each of the corresponding R, G, and B values of the pixel is between 0 and 1. This conversion from RGB color space to a LAB color space or an LCH color space associated with a LAB color space, such as CIE-LCH or OkLab-LCH, reduces color artifacts in the output HDR image. The resulting image having increased saturation of RGB values, LCH color space, and/or reduced chromaticity of each pixel without modified lightness or hue can be used as an output image, e.g., provided to a display system for display on an output device or stored on a storage device.

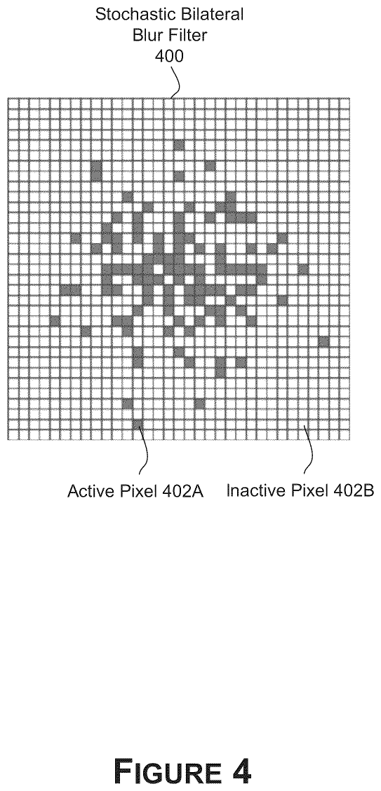

FIG. 4 illustrates an example stochastic bilateral blur filter 400, according to various embodiments. The stochastic bilateral blur filter 400 includes a grid of pixels 402, each of which corresponds to a pixel of an input image 202. Each pixel 402 is either an active pixel 402A, e.g., a pixel that is in an “on” or “1” state and is shown as a filled square, or an inactive pixel 402B, e.g., a pixel that is in an “off” or “0” state and is shown as an empty square. The stochastic bilateral blur filter 400 is an example of a bilateral blur filter 308 in which active pixels 402A conform to a random distribution. The execution engine 124 applies the filter to pixels of the input image 202, and accesses pixels of the input image 204 for which the corresponding pixels of the stochastic bilateral blur filter 400 are active. The active pixels 402B of the stochastic bilateral blur filter 400 are determined based on a probability of using each pixel in the input image 202, where the probability is determined according to a random distribution. The random distribution can be a Gaussian distribution, uniform distribution, or other suitable random distribution having specified properties, for example. The random distribution can be generated using a random number generator, for example.

Using the stochastic bilateral blur filter 400, the execution engine 124 accesses a subset of the adjacent or otherwise proximate pixels of each pixel in the input image 202 when calculating each output pixel. Accordingly, calculating output pixels using the stochastic bilateral blur filter 400 is substantially faster than using a non-stochastic bilateral blur filter, which would access all the neighborhood pixels (within a certain distance) of each pixel of the input image 202. The stochastic bilateral blur filter 400 accesses relatively few pixels of the input image 202 for each output pixel, but still produces output having accurate band locations, because banding filtering involves pixel values that are close to each other, and also because the color values in a band are often similar to each other.

In one or more embodiments, pixels of the input image 202 are accessed in a randomized pattern favoring the center of the image, as shown by the stochastic bilateral blur filter 400 shown in FIG. 4. In the example stochastic bilateral blur filter 400, the filled pixels 402A correspond to sampled (e.g., accessed) pixels of the input image 202 that are accessed during blur filtering in the region of a band edge, and empty pixels 402B represent samples that are skipped (e.g. not accessed). As such, using a dense filter to access all the shown pixels 402A and 402B is not needed. The bilateral blur filter 308 can also use blue-noise sampling to importance-sample the Gaussian footprint of a traditional bilateral filter to produce filter patterns such as the pattern shown in the example stochastic bilateral blur filter 400 shown in FIG. 4. Use of the stochastic bilateral blur filter 400 can reduce the number of samples (e.g., memory accesses) involved in blur filtering to the range of 8-32 samples to filter an input image 202, for example. Large-scale banding artifacts, e.g., in the range of 256×256 pixel regions, can be efficiently filtered using the stochastic bilateral blur filter 400. Further, since banding involves interpolation between pixels having similar values, the noise resulting from sampling a sparse portion of the image instead of a denser portion of the image is visually imperceptible. Further, at low sample counts, the filter gracefully degrades to dithering, which is acceptable in lower-resolution or lower-end (e.g., mobile) devices.

The bilateral blur filter 308 operates on an input image 202 having a resolution that does not have high-frequency details, such as a resolution of 540p (960×540 pixels), for example. The bilateral blur filter 308 merges the portions of the 540p input image 202 from which banding was removed or reduced with portions of the higher-resolution original image that was down-sampled to form the 540p input image 202 The portions of the higher-resolution original image have higher-frequency details, but do not have banding artifacts. By performing de-banding on portions of the input image 202 instead of portions of the original input image, the bilateral blur filter 308 can perform de-banding at higher speed that would be possible on the original input image.

Since the banding removal described herein is performed on an SDR image prior to conversion to HDR, execution engine 124 can remove bands from SDR content by omitting the conversion to HDR. If output in HDR format is desired as output, execution engine 124 converts the de-banded image 310 to an output image 314 in HDR format using an inverse tone mapper 312. The output image 314 can be a 32-bit image, a 16-bit image, or an image having another suitable number of bits per pixel. If SDR format is desired as output, execution engine 124 can provide the de-banded image 310 as the output image 314.

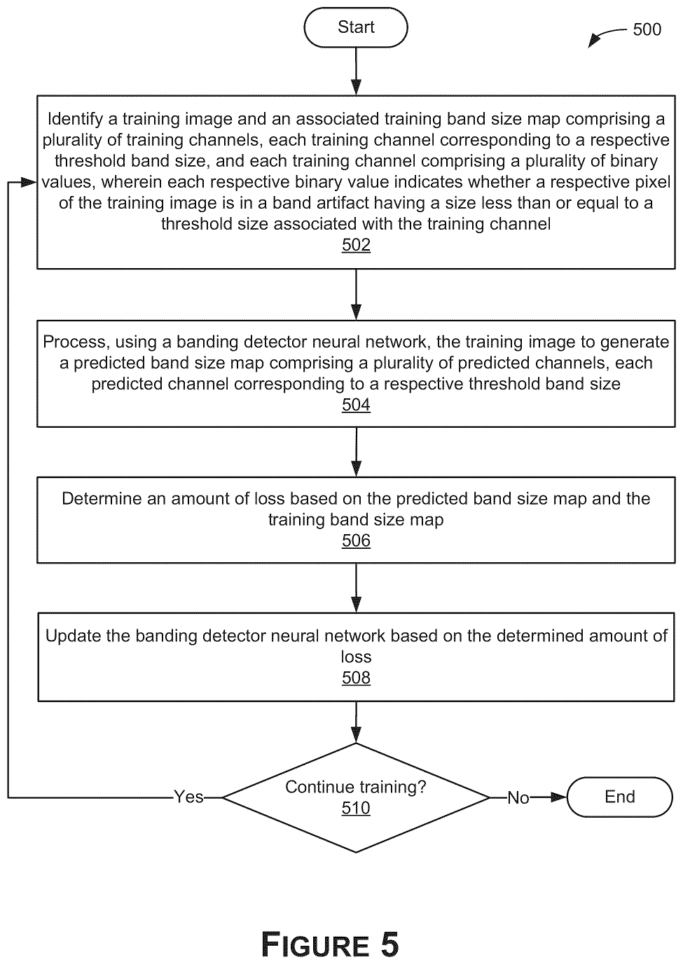

Now referring to FIG. 5, each block of method 500, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the system of FIGS. 1-2C. However, this method may additionally or alternatively be executed by any one system, or any combination of systems, including, but not limited to, those described herein. Further, the operations in method 500 can be omitted, repeated, and/or performed in any order without departing from the scope of the present disclosure.

FIG. 5 illustrates a flow diagram of a method 500 for training a banding detector network, according to various embodiments. As shown in FIG. 5, method 500 begins with operation 502, in which training engine 122 identifies a training input image 224 and an associated training band size map 226 comprising a plurality of training channels, each training channel corresponding to a respective threshold band size, and each training channel comprising a plurality of binary values, where each respective binary value indicates whether a respective pixel of the training image is in a band artifact having a size less than or equal to a threshold size associated with the training channel. The training image and associated training band size map 226 can be retrieved from training data 220, for example.

In operation 504, training engine 122 processes, using a banding detector network 204, the training input image 224 to generate a predicted band size map 206 comprising a plurality of predicted channels, each predicted channel corresponding to a respective threshold band size. The banding detector network 204 can be, for example, a Convolutional Neural Network (CNN) having multiple layers that process different levels of the receptive field of the input image. Other types of neural networks can be used, such as a transformer or a variational autoencoder.

In operation 506, training engine 122 determines an amount of band size map loss 210 based on the predicted band size map 206 and the training band size map 226. The predicted band size map 206 and target band size map 208 can be images or sets of images, and the loss 210 can be computed based on an image difference. The loss function can be a quadradic mean squared error function, cross-entropy function, weighted cross-entropy function, or other suitable loss function.

In operation 508, training engine 122 updates the banding detector network 204 based on the determined amount of loss. e.g., by updating weights or other parameters of the banding detector network 204 using backpropagation or other suitable training technique. In operation 510, training engine 122 determines whether or not training using the loss is to continue. For example, training engine 122 could determine that the banding detector network 204 should continue to be trained using the loss until one or more conditions are met. These condition(s) include (but are not limited to) convergence in the parameters of the banding detector network 204, the lowering of the loss to below a threshold, and/or a certain number of training steps, iterations, batches, and/or epochs. While training continues, training engine 122 repeats steps 502-508.

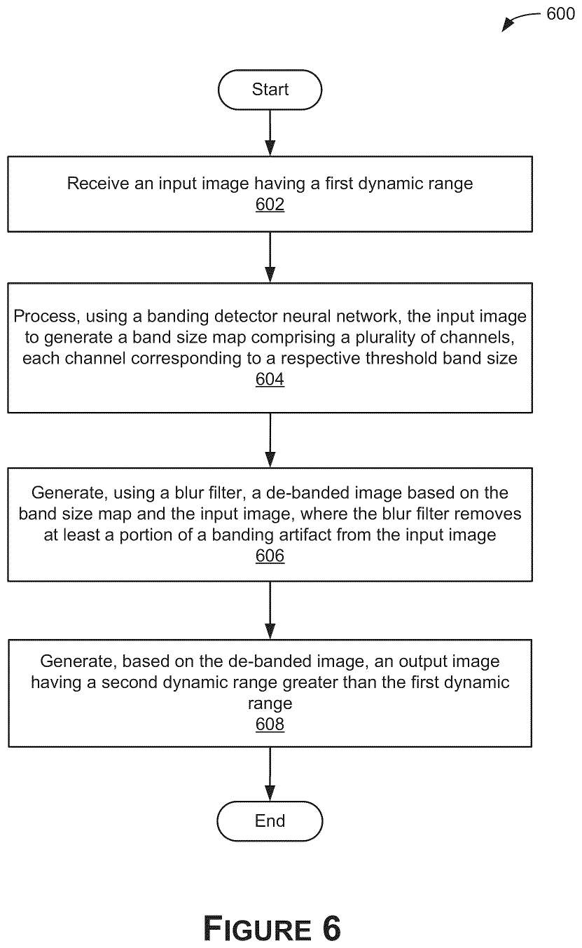

Now referring to FIG. 6, each block of method 600, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 600 is described, by way of example, with respect to the system of FIGS. 1-2C. However, this method may additionally or alternatively be executed by any one system, or any combination of systems, including, but not limited to, those described herein. Further, the operations in method 500 can be omitted, repeated, and/or performed in any order without departing from the scope of the present disclosure.

FIG. 6 illustrates a flow diagram of a method 600 for reducing banding artifacts in an image, according to various embodiments. As shown in FIG. 6, method 600 begins with operation 602, in which execution engine 124 receives an input image having a first dynamic range. The first dynamic range can be, e.g., SDR. The input image can be a frame of content being streamed or displayed, or a portion of such content, for example.

In operation 604, execution engine 124 processes, using a banding detector neural network, the input image to generate a band size map that identifies at least one banding artifact in the input image. For example, the band size map can identify a predicted band size and a predicted pixel location of the at least one banding artifact in the image. The band size can represent a width of a band. A band can be a region of an image 202 between two parallel lines or between two curved lines, created as side-effects of quantizing the image levels, or using another image or video compression method. The width of a band can be a distance (e.g., a perpendicular or normal distance) between the two lines of the band. The predicted pixel location can be a location (e.g., x and y coordinates) of a pixel that is in the band. For example, there can be eight channels 230-237 as shown in FIG. 2C. Each threshold band size can represent a width of a band. A band can be a region of an image 202 between two parallel lines or between two curved lines, created as side-effects of quantizing the image levels, or using another image or video compression method. The width of a band can be a distance (e.g., a perpendicular or normal distance) between the two lines of the band. As another example, the band size map can include a plurality of scalar band size values, such that each scalar band size value in the plurality of scalar band size values specifies a respective predicted size of a respective corresponding band. Further, each respective corresponding band can include a pixel to which the scalar band size value corresponds in the band size map.

Each channel includes a plurality of values, each of which corresponds to a pixel of the input image 202 and indicates whether a size of a band that includes the pixel is greater than a respective threshold band size that corresponds to the respective channel. The respective threshold band size can be in a sequence of progressively increasing threshold band sizes that form nested ranges of band sizes.

In operation 606, execution engine 124 generates, using a blur filter, a de-banded image based on the band size map and the input image, wherein the blur filter removes at least a portion of a banding artifact from the input image. The blur filter can remove the at least a portion of the banding artifact from an area of the input image, where the area of the input image is identified based at least in part on a threshold band size that corresponds to a channel of the band size map. The blur filter can use the respective threshold band size to remove the respective band. The blur filter can be a bilateral blur filter that samples one or more pixels of the input image. The bilateral blur filter can be a stochastic bilateral blur filter that samples a subset of pixels of the input image. Each pixel in the subset is selected based on a probability of using the pixel, where the probability is determined based on a random distribution such as a Gaussian distribution.

In operation 608, execution engine 124 generates, based on the de-banded image, an output image having a second dynamic range greater than the first dynamic range. The second dynamic range can be, for example, HDR, or other dynamic range greater than the first dynamic range. The execution engine 124 can convert the de-banded image 310 to a 32-bit output image 314 in HDR format using an inverse tone mapper 312, for example.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs) that process text, audio, and/or sensor data, systems for performing light transport simulation, systems for performing collaborative content creation for 3D assets, systems implemented at least partially using cloud computing resources, and/or other types of systems.

### Example Computing Device

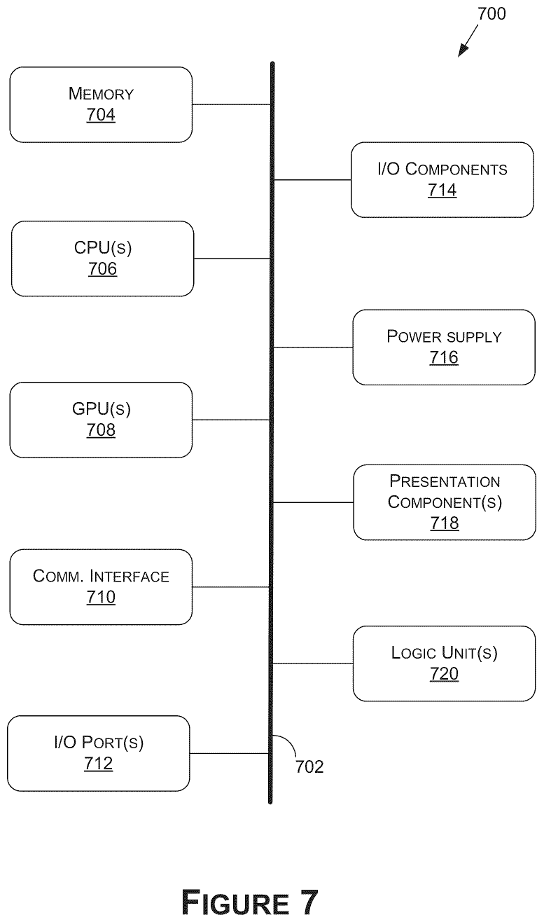

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In various embodiments, one or more CPU(s) 706, GPU(s) 708, and/or logic unit(s) 720 are configured to execute one or more instances of training engine 122 and/or execution engine 124. A banding detector network 204 generated by training engine 122 can then be used by execution engine 124 and/or additional components to remove banding artifacts from input images.

The communication interface 710 may include one or more receivers, transmitters, and/or transceivers that enable the computing device 700 to communicate with other computing devices via an electronic communication network, included wired and/or wireless communications. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

In sum, the disclosed techniques use a banding detector neural network to identify parts of an input image that contain banding, or will likely contain banding after conversion to HDR, and then use a blur filter to remove or reduce the banding by blurring the input image at or near the edges of the bands. The input image can be an SDR image, for example. The resulting de-banded image produced by the blur filter can be converted to a higher dynamic range image, such as an HDR image, in which banding is not present or is reduced. More specifically, the banding detector network predicts the sizes of bands in pixel regions of the input image. The size of a band is referred to herein as a band size. The output of the banding detector network is a band size map that includes a set of band size values, each of which corresponds to a respective pixel of the input image. Each band size value in the output map indicates a predicted size of a band that contains the corresponding pixel location in the input image. The banding detector network can be a nested binary classifier that has a wide receptive field capable of detecting wide bands, and that outputs the band size map in the form of binary classifications associated with pixels of the input image. In the band size map that contains binary classifications, each band size value is a binary value that indicates whether the corresponding pixel of the image is in a band having a size greater than a threshold band size. The threshold band size can be associated with the band size map, and the banding detector network can output multiple band size maps, each associated with a different threshold band size. Each band size map thus corresponds to a range of band sizes, and each value in the band size map indicates whether a respective pixel is in a band of a size that falls within the range associated with the band size map. The range associated with a band size map can include the lower (or higher) ranges associated with other band size maps, so that the ranges are nested, as described in further detail herein.

The band size map and the input image are provided as input to a bilateral blur filter, which generates a de-banded image by removing the bands indicated by the band size map from the input image. Since the band size map associates band sizes with pixels, the band sizes can vary as appropriate for different pixel locations. The bilateral blur filter can be a stochastic bilateral blur filter that accesses a subset of the neighborhood pixels in the input image when calculating each output pixel. The stochastic bilateral blur filter determines a probability of using each neighborhood pixel in the input image according to a random distribution, applies the filter to pixels of the input image, and accesses pixels according to the probability. An inverse tone mapping then increase the dynamic range of the de-banded image.

One technical advantage of the disclosed techniques relative to prior approaches is the ability to remove banding artifacts from an image in a short amount of time. Prior approaches generate SDR images at rate lower than video frame rates, so those techniques convert SDR content to a resulting HDR file, which is stored in persistent storage such as a disk or database. The disclosed techniques remove banding artifacts in real time, so that SDR content can be converted to HDR content while the content is being transmitted over a network. The stochastic bilateral blur filter accesses relatively few pixels of the input image for each output pixel, but still produces accurate band locations as output, because the color values in a band are often similar to each other. Prior approaches are substantially slower and are unable to process images at a rate sufficient to remove bands from video frames while a video is being streamed from a server to a client device via a computer network. Instead, prior approaches perform de-banding on video data prior to streaming, e.g., by converting a video file to a de-banded video file prior to streaming. The de-banded video file consumes additional storage space. Another technical advantage of the disclosed techniques is better preservation of textures from the SDR input image in the HDR output image and elimination of more of the banding artifacts than are eliminated in prior approaches. The banding detector network has a wide receptive field, which enables the banding detector network to identify bands having edges that are far apart from each other.

1. In some embodiments, a method comprises receiving an input image having a first dynamic range; processing, using a neural network, the input image to generate a band size map that identifies at least one banding artifact in the input image; generating, using a blur filter, a de-banded image based on the band size map and the input image, wherein the blur filter removes at least a portion of the at least one banding artifact from the input image; and generating, based on the de-banded image, an output image having a second dynamic range that is greater than the first dynamic range.

2. The method of clause 1, wherein the band size map identifies at least one of a predicted band size or a predicted pixel location of the at least one banding artifact in the image.

3. The method of clauses 1 or 2, wherein the band size map includes a plurality of channels, wherein at least one channel of the plurality of channels corresponds to a respective threshold band size in a plurality of threshold band sizes, and wherein the predicted band size is specified in relation to one or more of the plurality of threshold band sizes.

4. The method of any of clauses 1-3, wherein the at least one channel in the plurality of channels is associated with a plurality of binary values, and at least one binary value in the plurality of binary values corresponds to a respective pixel of the input image and indicates whether a size of a banding artifact that includes the respective pixel is greater than a given threshold band size to which the given channel corresponds.

5. The method of any of clauses 1-4, wherein at least one of the plurality of binary values corresponds to a particular pixel that is included in the at least one banding artifact, and wherein the predicted pixel location of the at least one banding artifact is identified by a location of the particular pixel in the image.

6. The method of any of clauses 1-5, wherein the given threshold band size is in a sequence of progressively increasing threshold band sizes associated with the band size map.

7. The method of any of clauses 1-6, wherein the blur filter removes the at least a portion of the at least one banding artifact from an area of the input image, wherein the area of the input image is identified based at least in part on at least one of the predicted pixel location or a particular threshold band size that corresponds to a channel of the band size map.

8. The method of any of clauses 1-7, wherein the blur filter uses at least one of the predicted pixel location or the particular threshold band size to remove the respective band.

9. The method of any of clauses 1-8, wherein the band size map includes a plurality of scalar band size values, wherein each scalar band size value in the plurality of scalar band size values specifies a respective predicted size of a respective corresponding band.

10. The method of any of clauses 1-9, wherein each respective corresponding band includes a pixel to which the scalar band size value corresponds in the band size map.

11. The method of any of clauses 1-10, wherein the blur filter is a bilateral blur filter that samples one or more pixels of the input image.

12. The method of any of clauses 1-11, wherein the bilateral blur filter is a stochastic bilateral blur filter that samples a subset of pixels of the input image, wherein each pixel in the subset is selected based on a probability of using the pixel, and wherein the probability of using the pixel is determined based on a random distribution.

13. The method of any of clauses 1-12, wherein the neural network is trained based on an amount of loss between a target band size map associated with a training input image and a predicted band size map, wherein the predicted band size map is generated by the neural network based on the training input image.

14. The method of any of clauses 1-13, wherein the target band size map is generated based on the training input image using a band size-finding algorithm that determines a distance from at least one pixel of the training input image to a nearest pixel that differs from the pixel by more than a threshold amount in at least one color channel.

15. The method of any of clauses 1-14, wherein the first dynamic range comprises Standard Dynamic Range (SDR) and the second dynamic range comprises High Dynamic Range (HDR).

16. The method of any of clauses 1-15, wherein generating, based on the de-banded image, an output image comprises: increasing a saturation of one or more red, green, or blue values of at least one pixel of the output image; and reducing a chromaticity value of the at least one pixel of the output image to a reduced chromaticity value for which each Red, Green, and Blue (RGB) value is in a predetermined range.

17. The method of any of clauses 1-16, wherein reducing the chromaticity value of the at least one pixel of the output image comprises converting the output image from Red Green Blue (RGB) color space to CIE-LAB or OkLab, or a different LAB color space, or Luminance Chroma Hue (LCH) color space associated with CIE-LAB or OkLab, or a different LAB color space.

18. The method of any of clauses 1-17, wherein the input image is included in a frame of content being streamed or displayed.

19. In some embodiments, a processor comprises one or more processing units to perform operations comprising: receiving an input image having a first dynamic range; processing, using a neural network, the input image to generate a band size map that identifies at least one banding artifact in the input image; generating, using a blur filter, a de-banded image based on the band size map and the input image, wherein the blur filter removes at least a portion of the at least one banding artifact from the input image; and generating, based on the de-banded image, an output image having a second dynamic range greater than the first dynamic range.

20. In some embodiments, a system comprises: one or more processors to perform operations comprising: receiving an input image having a first dynamic range; processing, using a banding detector neural network, the input image to generate a band size map that identifies at least one banding artifact in the input image; generating, using a blur filter, a de-banded image based on the band size map and the input image, wherein the blur filter removes at least a portion of the at least one banding artifact from the input image; and generating, based on the de-banded image, an output image having a second dynamic range greater than the first dynamic range.

21. The system of clause 20, wherein the system comprises at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more large language models (LLMs); a system for generating synthetic data; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method, comprising:
receiving an input image having a first dynamic range;
processing, using a neural network, the input image to generate a band size map that identifies at least one banding artifact in the input image;
generating, using a blur filter, a de-banded image based on the band size map and the input image, wherein the blur filter removes at least a portion of the at least one banding artifact from the input image; and
generating, based on the de-banded image, an output image having a second dynamic range that is greater than the first dynamic range.

2. The method of claim 1, wherein the band size map identifies at least one of a predicted band size or a predicted pixel location of the at least one banding artifact in the image.

3. The method of claim 2, wherein the band size map includes a plurality of channels, wherein at least one channel of the plurality of channels corresponds to a respective threshold band size in a plurality of threshold band sizes, and wherein the predicted band size is specified in relation to one or more of the plurality of threshold band sizes.

4. The method of claim 3, wherein the at least one channel in the plurality of channels is associated with a plurality of binary values, and at least one binary value in the plurality of binary values corresponds to a respective pixel of the input image and indicates whether a size of a banding artifact that includes the respective pixel is greater than a given threshold band size to which the given channel corresponds.

5. The method of claim 4, wherein at least one of the plurality of binary values corresponds to a particular pixel that is included in the at least one banding artifact, and
wherein the predicted pixel location of the at least one banding artifact is identified by a location of the particular pixel in the image.

6. The method of claim 4, wherein the given threshold band size is in a sequence of progressively increasing threshold band sizes associated with the band size map.

7. The method of claim 1, wherein the blur filter removes the at least a portion of the at least one banding artifact from an area of the input image, wherein the area of the input image is identified based at least in part on at least one of the predicted pixel location or a particular threshold band size that corresponds to a channel of the band size map.

8. The method of claim 7, wherein the blur filter uses at least one of the predicted pixel location or the particular threshold band size to remove the respective band.

9. The method of claim 1, wherein the band size map includes a plurality of scalar band size values, wherein each scalar band size value in the plurality of scalar band size values specifies a respective predicted size of a respective corresponding band.

10. The method of claim 9, wherein each respective corresponding band includes a pixel to which the scalar band size value corresponds in the band size map.

11. The method of claim 1, wherein the blur filter is a bilateral blur filter that samples one or more pixels of the input image.

12. The method of claim 11, wherein the bilateral blur filter is a stochastic bilateral blur filter that samples a subset of pixels of the input image, wherein each pixel in the subset is selected based on a probability of using the pixel, and wherein the probability of using the pixel is determined based on a random distribution.

13. The method of claim 1, wherein the neural network is trained based on an amount of loss between a target band size map associated with a training input image and a predicted band size map, wherein the predicted band size map is generated by the neural network based on the training input image.

14. The method of claim 13, wherein the target band size map is generated based on the training input image using a band size-finding algorithm that determines a distance from at least one pixel of the training input image to a nearest pixel that differs from the pixel by more than a threshold amount in at least one color channel.

15. The method of claim 1, wherein the first dynamic range comprises Standard Dynamic Range (SDR) and the second dynamic range comprises High Dynamic Range (HDR).

16. The method of claim 1, wherein generating, based on the de-banded image, an output image comprises:
increasing a saturation of one or more red, green, or blue values of at least one pixel of the output image; and
reducing a chromaticity value of the at least one pixel of the output image to a reduced chromaticity value for which each Red, Green, and Blue (RGB) value is in a predetermined range.

17. The method of claim 16, wherein reducing the chromaticity value of the at least one pixel of the output image comprises converting the output image from Red Green Blue (RGB) color space to CIE-LAB or OkLab, or a different LAB color space, or Luminance Chroma Hue (LCH) color space associated with CIE-LAB or OkLab, or a different LAB color space.

18. The method of claim 1, wherein the input image is included in a frame of content being streamed or displayed.

19. A processor comprising:
one or more processing units to perform operations comprising:
receiving an input image having a first dynamic range;
processing, using a neural network, the input image to generate a band size map that identifies at least one banding artifact in the input image;
generating, using a blur filter, a de-banded image based on the band size map and the input image, wherein the blur filter removes at least a portion of the at least one banding artifact from the input image; and
generating, based on the de-banded image, an output image having a second dynamic range greater than the first dynamic range.

20. A system comprising:
one or more processors to perform operations comprising:
receiving an input image having a first dynamic range;
processing, using a banding detector neural network, the input image to generate a band size map that identifies at least one banding artifact in the input image;
generating, using a blur filter, a de-banded image based on the band size map and the input image, wherein the blur filter removes at least a portion of the at least one banding artifact from the input image; and
generating, based on the de-banded image, an output image having a second dynamic range greater than the first dynamic range.

21. The system of claim 19, wherein the system comprises at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more large language models (LLMs);
a system for generating synthetic data;
a system incorporating one or more virtual machines (VMs);
a system implemented at least partially in a data center; or
a system implemented at least partially using cloud computing resources.
